(19) United States
(12) Patent Application Publication
(10) Pub. No.: US 2002/0039402 A1
(43) Pub. Date: Apr. 4, 2002

(54) X-ray cassette holder

(76) Inventor: Joseph Hecker, Rapid City, SD (US)

Correspondence Address: Gene R. Woodle, 3516 Woodle PL., Rapid City, SD, 57702, US

(21) Appl. No.: 09/970,484

(22) Filed: Oct. 2, 2001

Related U.S. Application Data
(60) Provisional application No. 60/237,046, filed on Oct. 2, 2000.

(51) Int. Cl. G03C 5/16; G03B 42/02

(52) U.S. Cl. 378/167; 378/182; 378/181

(57) ABSTRACT

Embodiments of an X-ray cassette holder to be used in conjunction with a conventional X-ray machine are disclosed which may be used to removably hold any of a variety of conventional X-ray cassettes. The cassette holder includes means for adjusting the height of the X-ray cassette above the floor or table and a handle such that the X-ray cassette may be held in an appropriate X-ray position by an operator at a distance from the X-ray machine.

### REFERENCE TOP RELATED APPLICATION

This application relies, in part, for priority upon the Provisional Patent Application filed by Joseph Hecker entitled X-Ray Cassette Holder. This Provisional Patent Application was filed Oct. 02, 2000 and assigned application No. 60/237,046.

### BACKGROUND OF THE INVENTION

1. Field of the Invention

The present invention relates generally to the taking of X-rays and more specifically to a device for holding a standard X-ray cassette.

2. Background Information

In the United States and throughout the world, thousands of X-rays are taken every day. Generally, an X-ray apparatus includes an X-ray generator which generates an X-ray beam which is collimated by a collimator to pass through a patient (the patient may be either human or an animal) and makes some sort of image on a receptor. In many cases, the receptor is film upon which an image of a patient's bones or other diagnostic areas are captured. The film is very often provided in a cassette to hold the film and standard cassettes are ordinarily 8″×10″, 10″×12″, or 14″×17″. In many cases the patient lays on an X-ray table or similar object and the X-ray is taken while the patent is laying down. In other cases, either because of the location of the injury or because of the location of the patient; an X-ray must be taken while the patient is standing or in some other position. Often the patient is an animal, such as a horse, and it is impossible to place the patient upon a standard table or similar object. In such cases the cassette must often be held by hand with the cassette on one side of the injury and the X-ray emitter on the other.

Taking X-rays in which the cassette must be held in place by hand or other improvised method creates a variety of problems for the person or persons taking the X-ray. Perhaps most importantly, it is well known that repeated exposure to X-rays is detrimental and the deleterious effects of X-rays vary by the inverse square of the distance. That is, the danger involved in repeated exposure to X-rays is 16 times as greater at two feet than it is at six feet. It is also well known that a better quality of X-ray is achieved if the cassette holding the X-ray film is held steady and it is very difficult to hold a cassette steady when it is held in the hand. Such difficulties would be obvious, for example, in taking an X-ray of the shoulder or neck of a horse. In addition, there are obvious dangers involved in simply being close to an animal such as a horse or a cow when an X-ray is being taken. Animals in such situations are often nervous, upset, or angry and persons taking X-rays close to such animals are in danger of being bit or kicked.

The invention presented in the present application is believed to solve, in a simple and effective fashion, problems which have long plagued persons engaged in taking X-rays in situations where the X-ray can not be taken while the patient is on a table or similar object: a X-ray cassette holder which provides a method of greatly increasing the distance between the operator and the X-ray emitting device, much improved stability of the X-ray cassette and film, and greatly increasing the distance between the operator and possibly dangerous animals.

The ideal X-ray cassette holder should provide a method of conveniently holding an X-ray cassette in situations in which the X-ray may not be taken while the patient is on a table or other conventional X-ray platform. The ideal X-ray cassette holder allows the cassette to be properly placed while allowing the operator to maintain a significant distance from the dangerous X-ray emitting device. The ideal X-ray cassette holder should also significantly improve the stability of the cassette over a hand held cassette. The ideal X-ray cassette holder should also provide a method whereby the operator may maintain a safe distance from possibly dangerous patients. The ideal X-ray cassette holder should also be simple, rugged, inexpensive, and easy to use.

### SUMMARY OF THE INVENTION

The X-ray cassette holder of the instant invention includes a frame which may be adjusted to hold most sizes of conventional X-ray cassettes in any orientation. The frame is attached to a variable position handle which may be used by the operator to hold the cassette in position while the operator is at some distance from the X-ray emitter and the patient. A variety of supports are provided and attached to the frame. The supports rest upon the ground to greatly improve stability and are adjustable so that the X-ray cassette may be supported above the ground at almost any height.

A lower frame is affixed to a hollow bracket. An upper frame is affixed to a slide which is movable along much of the length of the bracket. The slide fits outside of the bracket and includes means for adjustably affixing the slide to the bracket along the end of the bracket opposite the lower frame. Any of a number of standard X-ray film cassettes may be placed between the lower and upper frames and held securely in place by moving the upper frame toward the lower frame and securing the slide to the bracket when the upper frame is positioned tightly against the cassette.

A handle bracket may be adjustably secured to the bracket between the lower frame and the upper frame. The handle bracket also slides along the bracket and may be removably affixed in a variety of positions. A handle is rotatably affixed to the handle bracket and may be rotated through an 180 degree arc beginning in a position parallel to the bracket. Means are provided to hold the handle in any of eight positions throughout its arc of movement in the same plane as the lower and upper frames and the X-ray cassette. The handle also telescopes to nearly twice its length. The handle is secured to the handle bracket by a spring pin and may thus be quickly removed from the handle bracket.

A rod being about the same length or slightly longer than the bracket slides inside the bracket. Two screws, one at either end of the bracket, are threaded through threaded holes in the bracket, and the screws may be tightened to hold the rod in place at nearly any position within the bracket. That is, the rod may be held by the screws at any position from being nearly totally contained within the bracket or extending for nearly all of its length outside either end of the bracket. Two legs are rotatably affixed to the base of the lower frame such that they may be rotated upon pins to a position perpendicular to the lower frame or rotated to align with the base of the lower frame.

One of the major objects of the present invention is to provide an X-ray cassette holder which provides a method of conveniently holding an X-ray cassette in situations in which the X-ray may not be taken while the patient is on a table or other conventional X-ray platform.

Another objective of the present invention is to provide for proper placement of the cassette while allowing the operator to maintain a significant distance from the dangerous X-ray emitting device.

Another objective of the present invention is to significantly improve the stability of the cassette over a hand held cassette.

Another objective of the present invention is to provide a method whereby the operator may maintain a safe distance from possibly dangerous patients when taking X-rays.

Another objective of the present invention is to provide an X-ray cassette holder which is simple, rugged, inexpensive, and easy to use.

These and other features of the invention will become apparent when taken in consideration with the following detailed description and the drawings.

### BRIEF DESCRIPTION OF THE DRAWINGS

FIG. 1 is a side view of the X-ray cassette holder of the instant invention;

FIG. 2 is a rear view of the X-ray cassette holder of the instant;

FIG. 3 is a detail view of a portion of the X-ray cassette holder of the instant invention shown in FIG. 1;

FIG. 4 is a second detail view of a different portion of the X-ray cassette holder of the instant invention shown in FIG. 1;

FIG. 5 is a side view of the X-ray cassette holder of the instant invention showing the invention in an alternate position; and

FIG. 6 is a side view of the X-ray cassette holder of the instant invention showing the invention in another alternate position.

### DESCRIPTION OF A PREFERRED EMBODIMENT

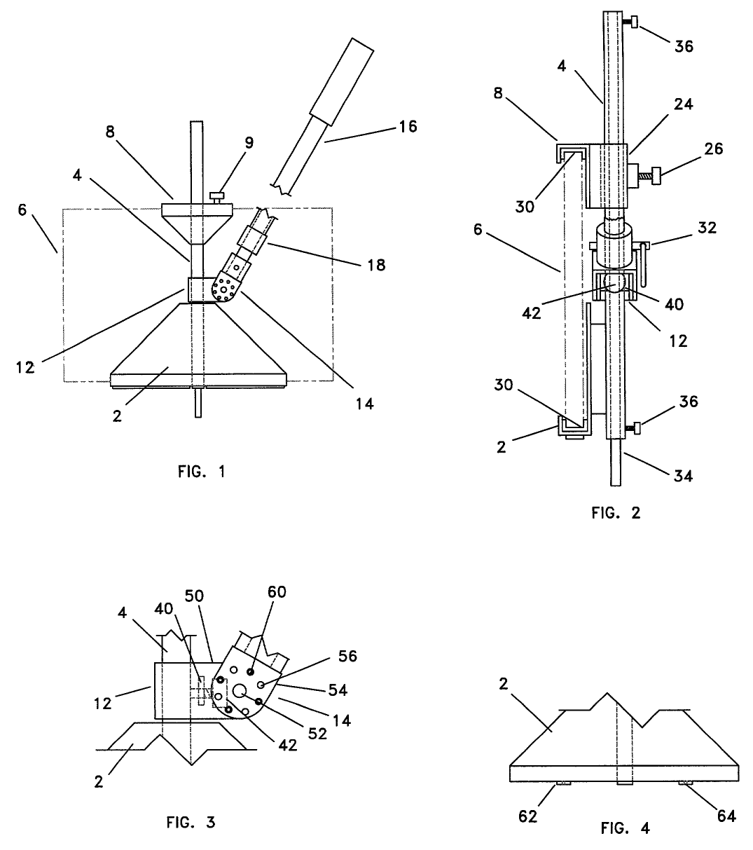

Referring to the drawings, FIGS. 1 through 6, there is shown a preferred form of the X-ray cassette holder embodying the present invention. The X-ray cassette holder of the instant invention may be used with any of a number of conventional X-ray film cassettes to hold such a cassette in a safe and stable position in those cases in which the patient may not be placed on an X-ray table or similar device.

Referring to FIG. 1, a side view of the X-ray cassette holder of the instant invention is shown. A lower frame 2 is affixed to a bracket 4. The size and shape of the lower frame 2 is such that the base and configuration of said lower frame 2 may securely hold any of a number of sizes of conventional X-ray film cassettes 6. The bracket 4 protrudes upward from the base of said lower frame 2. An upper frame 8 is slidably affixed to said bracket 4 above said lower frame 2. The upper frame 8 is also configured such that said upper frame 8 may securely hold the cassettes 6. Said bracket 4 is of sufficient length that said upper frame 8 may be slid far enough away from said lower frame 2 to accommodate the size of said cassette 6 which is intended to be used. A handle bracket 12 is slidably affixed to said bracket 4 between said lower frame 2 and said upper frame 8. A handle mount 14 is rotatable in the plane of said lower frame 2, said upper frame 8, and said cassette 6 and affixed to said handle bracket. A handle 16 is removably affixed to the handle mount 14. The handle 16 is a two piece unit with a lower portion which fits inside the upper portion and may be telescoped. A conventional telescope nut 18 may be loosened to allow said handle 16 to telescope or tightened to hold the two pieces of said handle 16 in any telescoped or untelescoped position. A level 9 is affixed to the top of said upper frame 8 by which an operator may insure that said bracket 4 is vertical.

Referring now to FIG. 2, a rear view of the instant invention is shown. In this Figure most of said handle 16 is not shown to improve clarity. A slide 24 provides the means by which said upper frame 8 is affixed to said bracket 4. The slide 24 may slide along most of the upper portion of said bracket 4 away from said lower frame 2. A slide nut 26 is threaded into a threaded hole in said slide 24 opposite said upper frame 8. Once said frame 8 has been slid to the appropriate position, it may be held in place by tightening the slide nut 26 against the outer surface of said bracket 4. The base of said lower frame 2 and the top of said upper frame 8 have the general shape of a “U” with the openings of the “U's” toward said cassette 6. Foam pads 30 are provided on the inside surfaces of the “U's” formed by said lower frame 2 and said upper frame 8. Said cassette 6 may be placed within the “U” of said lower frame 2 and said upper frame 8 slid down said bracket 4 until said cassette 6 is held within said lower frame 2 and said upper frame 8. Said upper frame 8 may then be held securely in place by tightening said slide nut 26. The foam pads 30 protect said cassette 6 from damage and, by deforming, help to hold said cassette 6 securely. Said handle 16 is removably affixed to the handle mount 14 by means of a conventional spring pin 32 which fits through holes in said handle 16 and said handle mount 14. A rod 34, having a length about the same length as said bracket 4 slides inside the length of said bracket 4. Two threaded rod nuts 36 may be screwed into two threaded holes, one at either end of said bracket 4. The rod 34 may be almost totally enclosed within said bracket 4 or extended for a part or most of its length out either the top or bottom of said bracket 4 and held in extended position by tightening the rod nuts 36. Said handle bracket 12 includes a flange 40 which is parallel to said bracket 4 and slightly away from said bracket 4. A threaded bracket nut 42 may be threaded through a threaded hole in the flange 40 and, when tightened, act to hold said handle bracket in position against said bracket 4. A spring 48 (not shown) connects said upper frame 8 and said lower frame 2 and acts to pull said upper frame 8 toward said lower frame 2. The spring 48 thus aids in holding and positioning said cassette 6.

Now referring to FIG. 3, a detail view of a portion of FIG. 1 is shown. Said handle bracket 12 includes two handle flanges 50 which protrude rearward and are slightly farther apart than the width of said bracket 4. Each of the handle flanges 50 include a flange pin 52 which protrudes outward. Said handle mount 14 includes two mount flanges 54. The inner surfaces of the mount flanges 54 are the same distance apart as the outer surfaces of said handle flanges 50. Said handle mount 14 is affixed to said handle bracket 12 by forcing the flange pins 52 through complimentary holes in said mount flanges 54. Said handle mount 12, and consequently said handle 16, are therefore rotatable about said flange pins 52. There is a series of mount holes 56 through said mount flanges 54 in a circular array around said flange pins 52. There is a complimentary series of bracket knobs 60, also in a circular array which protrude outward from said mount flanges 54 through the mount holes 56. Said handle mount 14 may be rotated about said flange pins 52 and said handle mount 14 and said handle 16 held in place in those positions in which said bracket knobs 60 protrude through said mount holes 56. This view also shows the position of said flange 40 and said bracket nut 42.

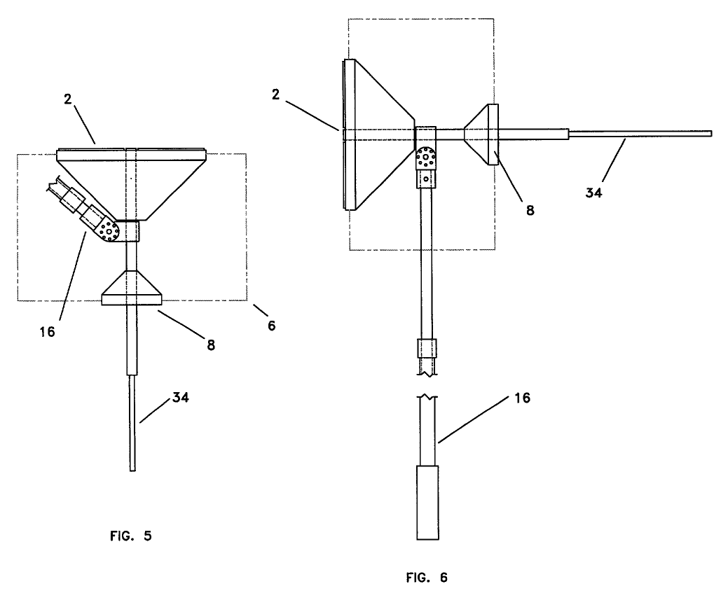

Now referring to FIG. 4, a detail view of a different portion of FIG. 1 is shown. Two feet 62 are rotatably attached to the bottom of the base of said lower frame 2 at their center by two foot pins 64. The feet are slightly shorter than half the length of the base of said lower frame 2 and may be rotated so that they are either parallel to or perpendicular to the base of said lower frame 2. When said feet 62 are parallel to the base of said lower frame 2, they do not protrude beyond the base.

In operation, a cassette 6 is inserted between said lower frame 2 and said upper frame 8 and held in place as described above. Said cassette 6 may then be positioned at virtually any height from floor level to a height slightly greater than the telescoped length of said handle 16. The position shown in FIG. 1 might be used, for example, to take an X-ray of the ankle of a horse. Said rod 34 is extended until, with the end of said rod 34 on the floor, said cassette 6 is at the appropriate height to X-ray a horse's ankle. Because said rod 34 rests upon the floor or the ground, said cassette 6 is much more stable and much less likely to move than if an operator attempted to hold said cassette 6 in position by hand. Said handle 16 may be telescoped to its greatest length when the X-ray is taken. Because the operator is holding said handle 16 rather than said cassette 6, the operator is much further away from the dangerous X-ray emission and from the potentially dangerous horse when the X-ray is taken.

As shown in FIG. 4, the X-ray cassette holder of the instant invention may also be used to take X-rays at ground level. Said handle 16 may be removed from said handle mount 14 by removing said spring pin 32. With said feet 62 turned perpendicular to said lower frame 2, said cassette 6 is self supporting on the floor and the operator need have no contact with the X-ray cassette holder. In this configuration, the X-ray cassette holder may also be used to take X-rays on a table top or similar location.

FIG. 5 shows a position of the instant invention which may be used to take X-rays at a position higher than that shown in FIG. 1. In this position said lower frame 2 is above said upper frame 8 and said rod 34 is extended downward to the appropriate position before being held in place with one of said rod nuts 36. Said handle 16 may be rotated to any convenient position and used to hold said cassette 6 steadily in place.

FIG. 6 shows a position of the instant invention which may be used to take X-rays at a position higher than that shown in FIG. 5. In this position, said handle 16 supports said cassette 6 and the X-ray cassette holder is held by said rod 34 which has been extended to its full length. Said handle 16 may be telescoped to the appropriate height.

In the preferred embodiment of the X-ray cassette holder of the instant invention, all parts and elements, except those specifically mentioned below, are made from aluminum; but other materials having the same strength, weight, resistance to oxidation, etc. could be used. Elements of the instant invention which are not made of aluminum are conventional and capable of being purchased from a number of sources.

While preferred embodiments of this invention have been shown and described above, it will be apparent to those skilled in the art that various modifications may be made in these embodiments without departing from the spirit of the present invention.

I claim:

1. An X-ray cassette holder for use in conjunction with a conventional X-ray machine and any of a variety of conventional X-ray cassettes which contain, at least, X-ray film or a similar medium, such X-ray cassette holder having a top, a bottom, a forward end, and a rearward end which comprises:
(1) a frame which is adjustable and capable of holding securely any of a number of sizes of conventional X-ray cassettes;
(2) a hollow, vertical, bracket affixed to the frame;
(3) a pin slidable within the hollow interior of the bracket and being slightly longer than the length of said bracket;
(4) securing means affixed to said bracket and capable of securing the pin at any position within said bracket or protruding at any length downward from the bottom or upward from the top of said bracket; and
(5) a handle also affixed to said bracket;
whereby an X-ray cassette may be removably, but firmly, affixed within said frame and the X-ray cassette holder adjusted such that the cassette holder may be supported at the appropriate height by adjusting the length of said pin and the operator may use the handle to hold the X-ray cassette holder in a stable position away from the X-ray machine.

2. The X-ray cassette holder of claim 1 in which the handle is rotatably affixed to said bracket and capable of being fixed in a variety of rotated positions in the plane of the X-ray cassette.

3. The X-ray cassette holder of claim 1 in which the handle is telescoping and capable of having adjustable length.

4. The X-ray cassette holder of claim 1 in which said bracket is longer than the vertical length between the top and bottom of said frame.

5. The X-ray cassette holder of claim 2 in which said bracket is longer than the vertical length between the top and bottom of said frame.

6. The X-ray cassette holder of claim 3 in which said bracket is longer than the vertical length between the top and bottom of said frame.

7. The X-ray cassette holder of claim 2 in which the handle is telescoping and capable of having adjustable length.

8. The X-ray cassette holder of claim 7 in which said bracket is longer than the vertical length between the top and bottom of said frame.
